(19) United States
(12) Patent Application Publication
(10) Pub. No.: US 2006/0011705 A1
(43) Pub. Date: Jan. 19, 2006

(54) Compression bonding method

(76) Inventors: Ja-Nam Ku, Suwon-si (KR); Potapov Sergey, Yongin-si (KR)

Correspondence Address: SUGHRUE MION, PLLC, 2100 PENNSYLVANIA AVENUE, N.W., SUITE 800, WASHINGTON, DC, 20037, US

(21) Appl. No.: 10/532,965

(22) PCT Filed: May 22, 2003
(86) PCT No.: PCT/KR03/01009

§ 371 Date: Apr. 27, 2005

(30) Foreign Application Priority Data
Oct. 28, 2002 (KR) 10-2002--0065843

(51) Int. Cl. B23K 20/10

(52) U.S. Cl. 228/110.1

(57) ABSTRACT

A compression bonding method includes patterning a metal bonding film in predetermined shapes on a substrate; and disposing a bonded element above the metal bonding film and applying heat to the substrate and pressure to the bonded element, thereby bonding the bonded element to the substrate having the metal bonding film. Since the compression bonding method allows bonded elements having various shapes and sizes to be bonded to a substrate at a low temperature and pressure, manufacturing is simplified, and the compression bonding method can be applied to various sealing and packaging processes.

### CROSS-REFERENCE TO RELATED PATENT APPLICATIONS

This application claims the benefit of Korean Patent Application No. 10-2002-0065843, filed on Oct. 28, 2002, in the Korean Intellectual Property Office, the disclosure of which is incorporated herein in its entirety by reference.

### BACKGROUND OF THE INVENTION

1. Field of the Invention

The present invention relates to a compression bonding method, and more particularly, to a method of bonding glass to a substrate using compression bonding at a low temperature and a low pressure.

2. Description of the Related Art

A method using an adhesive, a soldering method, or a diffusion method can be used to bond glass to a substrate. In the method using an adhesive, glass is bonded to a substrate using an adhesive, such as polymer, plastic, or epoxy. The method using an adhesive is disadvantageous in that it is difficult to finely adjust the quantity of adhesive, it consumes a lot of time, a bonded structure is easy to crack, and bonded elements separate at high humidity. Moreover, an adhesive may become a source of contamination in optical communication systems or packaging technology, and therefore, a bonding method not using an adhesive is required. Although a bonding method using a metal has been proposed in this respect, it is not easy to bond glass to a substrate using a metal because the metal and the glass have different material properties.

When the soldering method is used, bonded portions are easily deformed, and poor temperature cycling results appear in package reliability tests. Moreover, the soldering method has a problem of creep relaxation due to fatigue. The diffusion method has disadvantages such as necessity of applying an additional electrostatic field, generation of elevated temperature heat, and necessity of using a special chemical mechanism for surface activation.

An example of a method of bonding glass to aluminum among metals is disclosed in U.S. Pat. No. 5,178,319, which directs to a method of bonding a glass sphere to a substrate.

FIG. 1 is a diagram illustrating a compression bonding method disclosed in U.S. Pat. No. 5,178,319. Referring to FIG. 1, in order to bond a glass sphere lens 11 to a silicon substrate 12, a surface of the silicon substrate 12, which is in contact with the glass sphere lens 11, is coated with an aluminum film 13. The glass sphere lens 11 is pressed in an arrow direction 15 using a compressing tool 14, and simultaneously, the aluminum film 13 is heated using a heater 16.

In this conventional compression bonding method, the aluminum film 13 is melted by heating the aluminum film 13 while pressing the glass sphere lens 11 so that the aluminum film 13 and the glass sphere lens 11 are fused together at a contact point therebetween. In order to bond the glass sphere lens 11 to the flat silicon substrate 12, a high temperature exceeding 300° C. and a pressure of hundreds of Mpa are required.

The above-described conventional compression bonding method can be used under the condition that an optical element to be bonded to the flat silicon substrate 12 has a curved surface like the glass sphere lens 11 and has a small size, that is, has a radius less than several millimeters. Since the optical element has a curved surface, it contacts the aluminum film 13 in one point. As such, when the optical element is pressed, pressure is concentrated in the point of contact, thereby concentrating energy in that point of contact. As a result, the lattice of the aluminum film 13 is easily dissociated, and therefore, the optical element can be bonded to the silicon substrate 12.

Such a conventional compression bonding method as described above can be effectively applied to small-sized optical elements such as optical fibers or compact lenses, but it cannot be effectively applied to large-sized optical elements having a flat contact surface. Although the coefficient of friction of an Al/Si composition needed for bonding is of the order of decimals, a ratio of a length to a thickness of an optical element having a flat surface is actually of the order of hundreds since pressure applied to the optical element is dispersed throughout the flat surface, and thus the coefficient of friction is too large to allow the structure of aluminum to be dissociated at any pressure. In order to bond the flat surface of an optical element to a substrate using the conventional compression bonding method, a high temperature and a high pressure must be applied to the optical element for a long period of time so that an aluminum film can be penetrated or forced to flow in side directions. It is difficult to perform this bonding process. Moreover, even if the bonding process is performed, it is very difficult to strongly bond the optical element to the substrate.

### SUMMARY OF THE INVENTION

The present invention provides a compression bonding method through which amorphous glass plates having various sizes is bonded to a silicon, ceramic, or metal substrate at a low temperature and a low pressure.

According to an aspect of the present invention, there is provided a compression bonding method including patterning a metal bonding film in predetermined shapes on a substrate; and disposing a bonded element above the metal bonding film and applying heat to the substrate and pressure to the bonded element, thereby bonding the bonded element to the substrate having the metal bonding film.

According to another aspect of the present invention, there is provided a compression bonding method including patterning a first metal bonding film in predetermined shapes on a substrate and patterning a second metal bonding film in the predetermined shapes on a bonded element; and disposing the bonded element above the first metal bonding film and applying heat to the substrate and pressure to the bonded element, thereby bonding the bonded element having the second metal bonding element to the substrate having the first metal bonding element.

Preferably, the substrate is made of silicon, metal, or ceramic. Preferably, the metal bonding film is made of aluminum, magnesium, zinc, or titanium.

Preferably, the predetermined shapes are stripes or dots.

Preferably, the bonded element is glass or metal.

Preferably, the heat is lower than 350° C.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a conventional compression bonding method disclosed in U.S. Pat. No. 5,178,319;

FIG. 2 is a diagram illustrating a compression bonding method according to a first embodiment of the present invention;

FIG. 3 is a diagram illustrating a compression bonding method according to a second embodiment of the present invention;

FIG. 4 is a diagram illustrating a compression bonding method according to a third embodiment of the present invention;

FIG. 5 is a diagram illustrating the principle of a compression bonding method according to the present invention;

FIGS. 6A through 6E are diagrams showing the stages in the compression bonding method according to the first embodiment of the present invention;

FIGS. 7 through 12 are photographs showing examples of a state in which an element is bonded to a substrate according to a compression bonding method according to the present invention; and

FIG. 13 is a diagram illustrating a compression bonding method according to a fourth embodiment of the present invention.

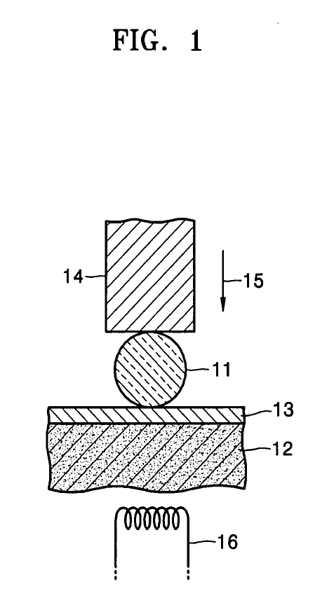

### DETAILED DESCRIPTION OF THE INVENTION

Hereinafter, preferred embodiments of a compression bonding method according to the present invention will be described in detail with reference to the attached drawings.

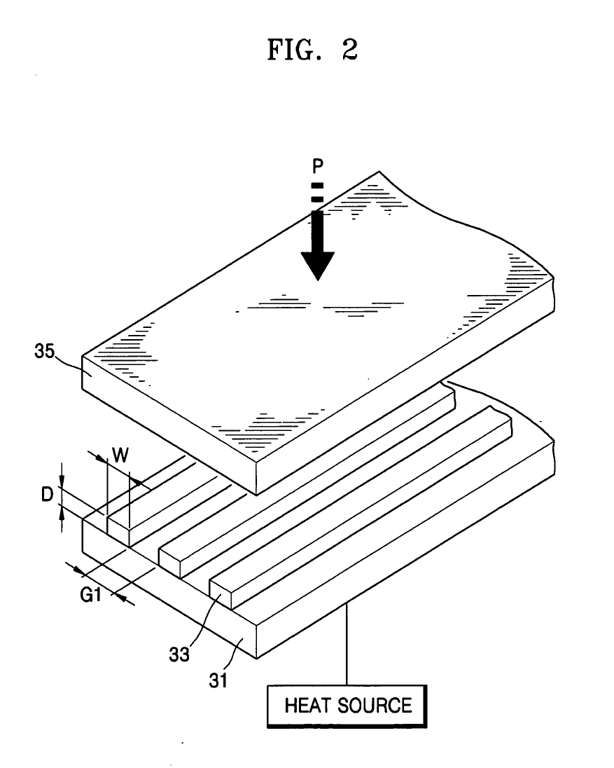

FIG. 2 shows the arrangement of a substrate, a metal bonding film, and an element to be bonded having a plate shape, which is hereinafter referred to as a bonded element, in a compression bonding method according to a first embodiment of the present invention.

Referring to FIG. 2, a metal bonding film 33 is patterned in stripes on a top surface of a substrate 31, and then a bonded element 35 having a plate shape is disposed above the metal bonding film 33. Next, the substrate 31 is heated, and simultaneously, the metal bonding film 33 is pressed from above. As a result, the metal bonding film 33 is deformed, and therefore, the bonded element 35 is bonded to the substrate 31. Here, a width “w” and a thickness D of the metal bonding film 33 and a gap G1 between the stripes vary with the types of materials of the substrate 31, the metal bonding film 33, and the bonded element 35.

The substrate 31 may be made of silicon, metal, or ceramic. The metal bonding film 33 may be made of aluminum (Al), magnesium (Mg), zinc (Zn), or titanium (Ti). It is preferable to use aluminum having a low melting point and a high adhesive power. The bonded element 35 may be an optical element made of glass or an electric element made of a metal. The type, size, and shape of the bonded element 35 may vary.

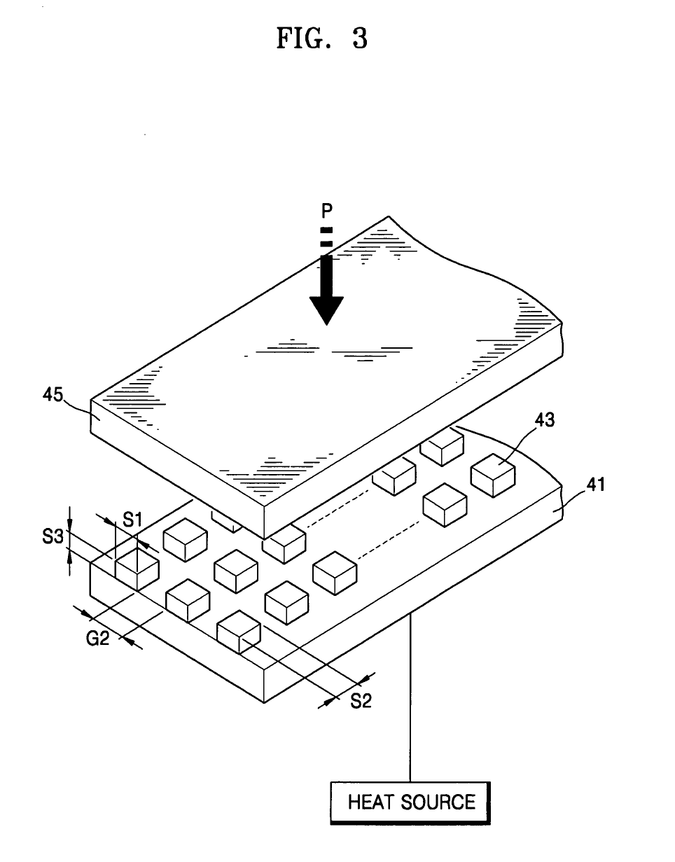

FIG. 3 shows the arrangement of a substrate, a metal bonding film, and a bonded element having a plate shape in a compression bonding method according to a second embodiment of the present invention. Unlike the first embodiment shown in FIG. 2 in which the metal bonding film 33 is patterned in stripes, a metal bonding film 43 in the second embodiment shown in FIG. 3 is patterned in square dots. Reference numeral 41 denotes a substrate, and reference numeral 45 denotes a bonded element. Since a gap G2 between the square dots of the metal bonding film 43 is greater than the gap G1 between the stripes of the metal bonding film 33 shown in FIG. 2, the metal bonding film 43 is more effective than the metal bonding film 33. A width S1, a length S2, and a height S3 of the square dots of the metal bonding film 43 may be the same but do not need to be the same.

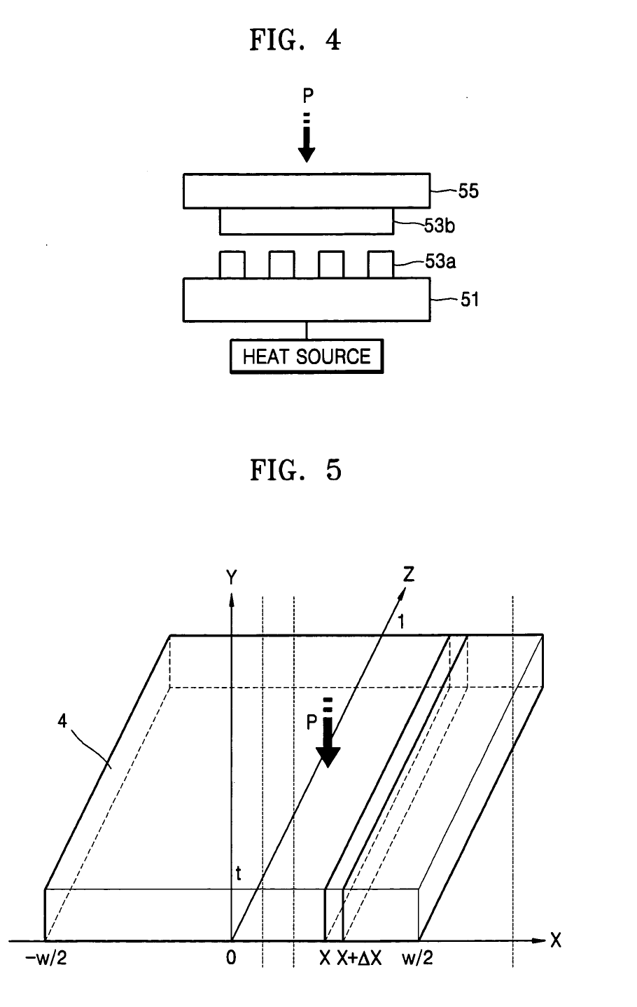

FIG. 4 shows the arrangement of a substrate, metal bonding films, and a bonded element having a plate shape in a compression bonding method according to a third embodiment of the present invention.

Similarly to the metal bonding film 33 shown in FIG. 2, a first metal bonding film 53a is patterned in stripes on a top surface of a substrate 51, and then a second metal bonding film 53b is patterned in stripes on a bottom surface of a bonded element 55. The first and second metal bonding films 53a and 53b are heated by heating the substrate 51 and simultaneously applying pressure on a top surface of the bonded element 55, so that the bonded element 55 is bonded to the substrate 51.

The third embodiment is different from the first embodiment in that the first and second metal bonding films 53a and 53b are respectively formed on the substrate 51 and the bonded element 55.

Other features of the substrates 41 and 51, the metal bonding films 43, 53a, and 53b, and the bonded elements 45 and 55 in the second and third embodiments are the same as those of the substrate 31, the metal bonding film 33, and the bonded element 35 described in the first embodiment.

FIG. 5 is a diagram illustrating the principle of a compression bonding method according to the present invention. A rectangular aluminum film 4 has a fixed width between 0 and 1 in a Z-direction and a thickness “t”. When a pressure P is applied to the aluminum film 4 in a Y-direction, the aluminum film 4 extends in an X-direction. The extension of the aluminum film 4 is restricted in the Z-direction.

The pressure P at the beginning of the extension of the aluminum film 4 in the X-direction will be calculated below. The pressure P decreases from the center of the aluminum film 4 to the circumference thereof in the X-direction due to friction between the aluminum film 4 and a substrate. When the pressure P is applied to the aluminum film 4, the thickness “t” of the aluminum film 4 decreases, and a width “w” thereof in the X-direction increases. That is, as a width “w” in the X-direction increases, a distance X increases, and thus a displacement ΔX in the X-direction increases according to Formula (1).

$$Δ X = \frac{X}{t} Δ Y \qquad ( 1 )$$

It can be inferred from Formula (1) that a high pressure is required for bonding since the thickness “t” must be decreased in order to increase the displacement ΔX of the aluminum film 4. It is necessary to know about a pressure in the X-direction in order to calculate a pressure needed to start moving the aluminum film 4. Firstly, a pressure at the beginning of extension of the aluminum film 4 is calculated under the boundary condition that pressures at widths ±w/2 of the aluminum film 4 are always the same at the beginning of the extension at different widths of films. The same friction coefficient “f” is applied on the top surface and the bottom surface of the aluminum film 4. A pressure variation ΔP in the X-direction is expressed by Formula (2).

$$Δ P ( X ) = - \frac{2 fP ( x ) Δ X}{t μ} \qquad ( 2 )$$

Here, μ is a Poisson coefficient. A solution of Formula (2) is given by Formula (3).

$$P ( x ) = P ( 0 ) exp ( - \frac{2 f}{t μ} x ) \qquad ( 3 )$$

A pressure P at the widths ±w/2 of the aluminum film 4 is given by Formula (4).

$$P ( w / 2 ) = P ( 0 ) exp ( - \frac{f}{t μ} w ) = P * \qquad ( 4 )$$

Accordingly, Formula (3) can be rewritten as Formula (5) based on Formula (4).

$$P ( x ) = P * exp ( \frac{fw}{t μ} ) exp ( - \frac{2 f}{t μ} x ) \qquad ( 5 )$$

An average pressure Pav can be calculated from Formula (5), as shown in Formula (6).

$$Pav = \frac{{\int }_{0}^{w / 2} P ( x ) ⅆ S}{S} = \frac{P * exp ( \frac{fw}{tu} ) tu}{wf} ( 1 - exp ( - \frac{fw}{tu} ) ) \qquad ( 6 )$$

The thickness “t” of stripes constituting the aluminum film 4 is the same as a gap G between the stripes, and the thickness “t” is set to 3 μm. Relationships between pressures when w=3, 30, and 100 μm, respectively, are expressed by Formulae (7) and (8) in cases where f=0.1 and where f=0.3, respectively.

$$\begin{matrix}\frac{Pav ( w = 30 )}{Pav ( w = 3 )} \approx 7.7 & ( 7 ) \\ \frac{Pav ( w = 100 )}{Pav ( w = 3 )} \approx 4615 & ( 8 )\end{matrix}$$

It can be inferred from Formulae (7) and (8) that a pressure during bonding varies considerably with the width “w” of the aluminum film 4. As shown in Formula (7), when the width “w” increases ten times, the pressure increases 7.7 times. As shown in Formula (8), when the width “w” increases 33.3 times, the pressure increases 4615 times. Although these are the results of a rough approximation, it can be inferred that bonding is almost impossible if the aluminum film 4 has a plate shape.

Referring to FIG. 5, since the aluminum film 4 is formed in a striped pattern, the aluminum film 4 can be easily extended in the horizontal direction due to the gap G between the stripes.

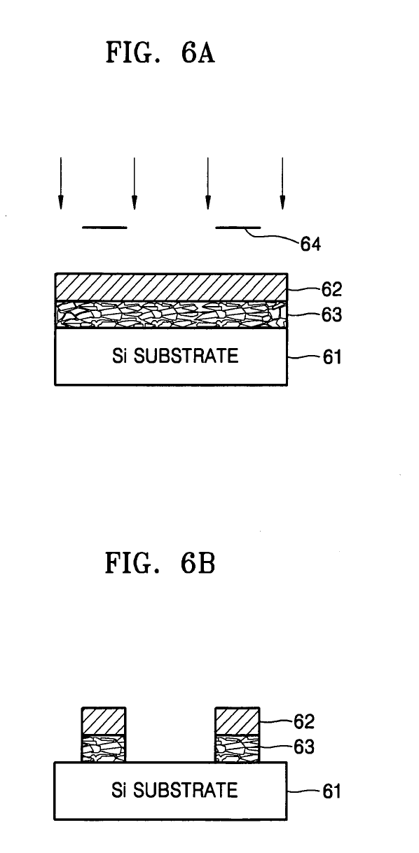

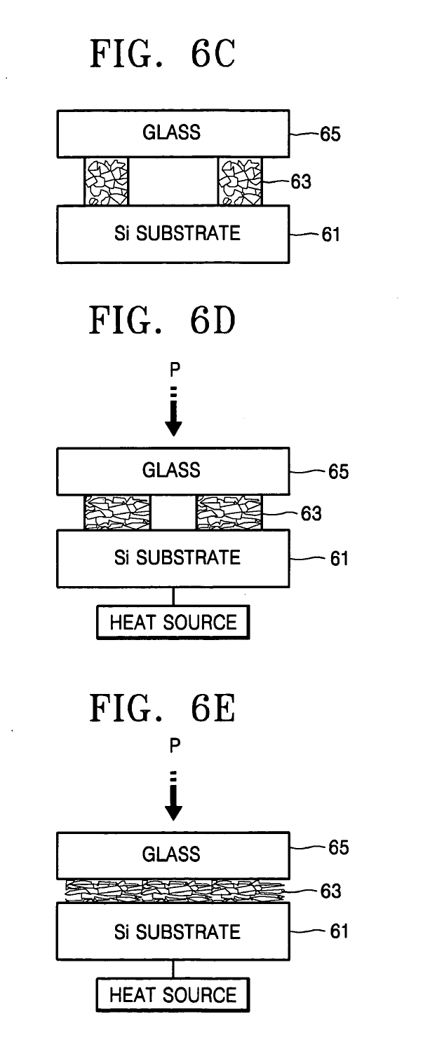

FIGS. 6A through 6E are diagrams showing the stages in the compression bonding method according to the first embodiment of the present invention. Here, an aluminum film is used as a metal bonding film, and a glass plate is used as a bonded element.

Referring to FIG. 6A, an aluminum film 63 is formed on a top surface of a substrate 61 using physical or chemical vapor deposition. Next, a photoresist 62 is deposited on the aluminum film 63, and a mask 64 having a predetermined shape is disposed above the photoresist 62. Thereafter, ultraviolet rays are radiated at the resulting structure. A photo process including exposure, development, and etching is performed on the resulting structure, thereby patterning the aluminum film 63 in stripes, as shown in FIG. 6B. Thereafter, a cleaning process is performed, thereby removing the photoresist 62 from the top surface of the aluminum film 63. Thereafter, as shown in FIG. 6C, a glass plate 65 is disposed on the aluminum film 63.

The aluminum film 63 may be patterned by directly performing an anisotropic etching process on the substrate 61 or using the substrate 61 having a striped pattern. When patterning the aluminum film 63 in square dots, the mask 64 having a square-dotted pattern or the substrate 61 having the same pattern can be used. In other words, various shapes of the mask 64 and the substrate 61 can be used depending on the desired shape of the aluminum film 63.

In order to bond the glass plate 65 to the substrate 61, as shown in FIG. 6D, a heat source 60 is connected to the substrate 61, thereby increasing the temperature of the substrate 61, and simultaneously, a pressure P is applied on the glass plate 65 from above. Then, the aluminum film 63 between the substrate 61 and the glass plate 65 is melted and starts extending in a side direction. Under an appropriate temperature and pressure conditions, as shown in FIG. 6E, the glass plate 65 is uniformly in close contact with the substrate 61, penetrating the aluminum film 63. The aluminum film 63 allows the glass substrate 65 to be steadily bonded to the substrate 61.

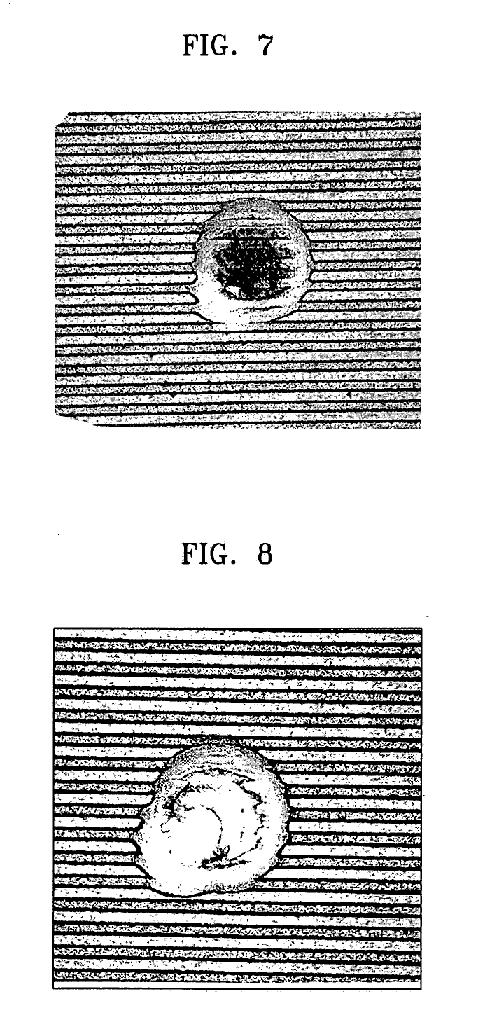

FIGS. 7 through 12 are photographs showing examples of a state in which a bonded element is bonded to a substrate through an aluminum film according to a compression bonding method according to the present invention.

FIGS. 7 and 8 are photographs of a state in which a glass sphere lens having a diameter of 800 μm was bonded to a substrate having an aluminum film stripe-patterned with a width of 18 μm and a gap of 10 μm by applying a heat of 300° C. FIG. 7 shows a state in which the aluminum film is stuck to the glass sphere lens, and FIG. 8 shows a state in which an AR coating of the glass sphere lens is stuck to the substrate. Here, a shear strength was 6 gf.

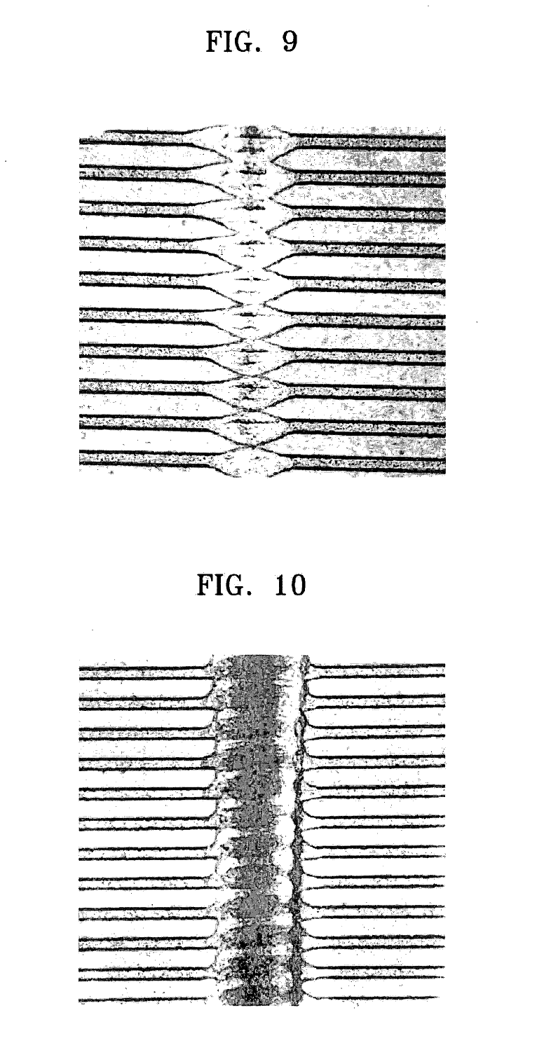

FIG. 9 is a photograph of a state in which an aspheric lens having a diameter of 1000 μm and a length of 810 μm was bonded to a substrate having an aluminum film stripe-patterned with a width of 18 μm and a gap of 20 μm by applying a heat of 320° C. and a pressure of 1500 gf. Here, a shear strength was 10 gf.

FIG. 10 is a photograph of a state in which an aspheric lens having a diameter of 1000 μm and a length of 810 μm was bonded to a substrate having an aluminum film stripe-patterned with a width of 18 μm and a gap of 20 μm by applying a heat of 320° C. and a pressure of 3900 gf. Here, a shear strength was 70 gf.

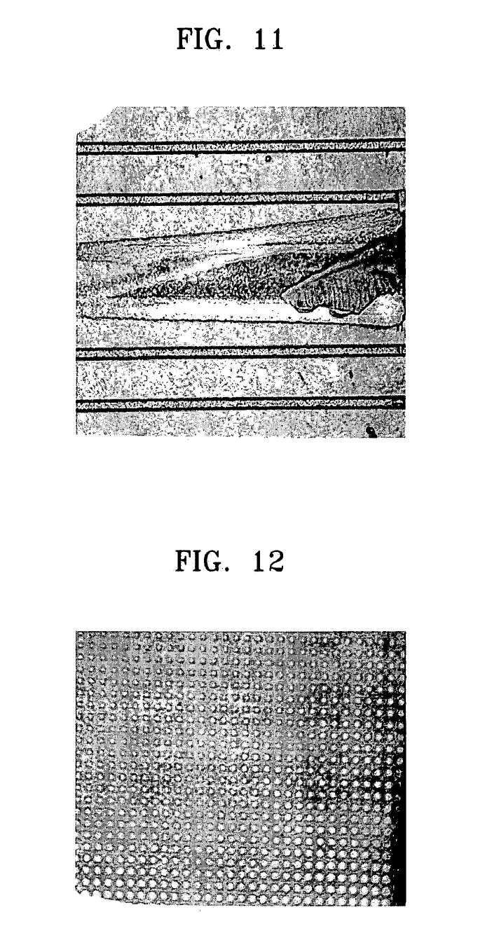

FIG. 11 is a photograph of a state in which an aspheric lens having a diameter of 1000 μm and a length of 810 μm was bonded to a substrate having an aluminum film stripe-patterned with a width of 18 μm and a gap of 50 μm by applying a heat of 320° C. and a pressure of 3900 gf. Here, a shear strength was 11.4 gf.

It can be inferred from the results of tests shown in FIGS. 9 through 11 that resistance to shear stress is highest when the width and the gap of the aluminum film ware similar to each other, the temperature was 320° C., and the pressure was 3900 gf.

When a glass plate was bonded to a substrate on which an aluminum film having a continuous plate shape was formed, a shear strength was almost zero. It was almost impossible to bond the glass plate to the substrate.

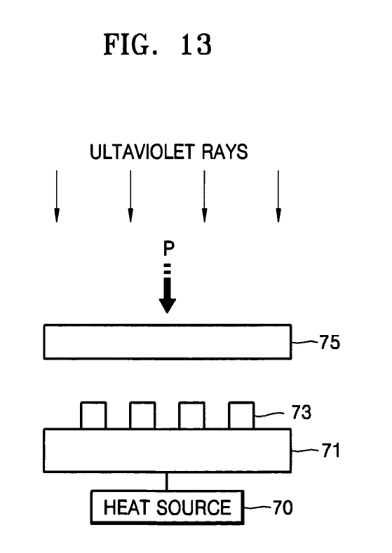

When a glass plate is bonded to a substrate having an aluminum film patterned in dots, high adhesive power is provided. FIG. 12 is a photograph of a state in which a glass plate was bonded to a substrate having an aluminum film patterned in square dots whose side was 18 μm in length by applying a heat of 320° C. and a pressure of 5000 gf. Here, a shear strength was 200 gf.

FIG. 13 is a diagram illustrating a compression bonding method according to a fourth embodiment of the present invention. The fourth embodiment is different from the first through third embodiments in that ultraviolet rays are further used. In the compression bonding method of the fourth embodiment, a metal bonding film 73 is patterned in stripes or dots on a substrate 71. Next, a bonded element 75 is disposed above the metal bonding film 73. Thereafter, ultraviolet rays are radiated at the top surface of the bonded element 75 along with the application of a pressure P on the bonded element 75 and the application of heat from a heat source 70 to the substrate 71, thereby bonding the bonded element 75 to the substrate 71. Due to the use of ultraviolet rays, heat and pressure necessary for bonding can be decreased. Another metal bonding film may be further formed on a bottom surface of the bonded element 75 before the bonded element 75 is bonded to the substrate 71.

According to the present invention, a metal bonding film is patterned in stripes or dots so that even a bonded element having a plate shape, which is impossible to bond using the conventional method, is easily bonded to a substrate. In addition, the present invention provides a high adhesive power even at a lower temperature and pressure than the conventional compression bonding method.

As described above, the present invention allows elements, including optical elements, having various shapes and sizes to be bonded to a substrate at a remarkably low temperature and pressure. Moreover, the present invention can be widely applied to any processes requiring packaging and sealing.

While this invention has been particularly shown and described with reference to preferred embodiments thereof, the preferred embodiments should be considered in descriptive senses only and not for purposes of limitation. Therefore, the scope of the invention is defined by the appended claims, not by the detailed description of the invention.

What is claimed is:

1. A compression bonding method comprising:
patterning a metal bonding film in predetermined shapes on a substrate; and
disposing a bonded element above the metal bonding film and applying heat to the substrate and pressure to the bonded element, thereby bonding the bonded element to the substrate having the metal bonding film.

2. A compression bonding method comprising:
patterning a first metal bonding film in predetermined shapes on a substrate and patterning a second metal bonding film in the predetermined shapes on a bonded element; and
disposing the bonded element above the first metal bonding film and applying heat to the substrate and pressure to the bonded element, thereby bonding the bonded element having the second metal bonding element to the substrate having the first metal bonding element.

3. The compression bonding method of claim 1 or 2, wherein the substrate is made of a material selected from the group consisting of silicon, metal, and ceramic.

4. The compression bonding method of claim 1 or 2, wherein the metal bonding film is made of a material selected from the group consisting of aluminum, magnesium, zinc, and titanium.

5. The compression bonding method of claim 1 or 2, wherein the predetermined shapes are stripes or dots.

6. The compression bonding method of claim 1 or 2, wherein the bonded element is glass or metal.

7. The compression bonding method of claim 1 or 2, wherein the heat is lower than 350° C.
